(19) United States
(12) Patent Application Publication
(10) Pub. No.: US 2026/0116110 A1
(43) Pub. Date: Apr. 30, 2026

(54) MULTILAYER RIBBON DEVICE COMPRISING AN ENDLESS RIBBON FOR THERMAL TRANSFER PRINTING APPARATUS

(71) Applicant: ARMOR, NANTES (FR)

(72) Inventors: Frans HEGGE, Hamont-Achel (BE); Juan RODRIGUEZ, As (BE)

(21) Appl. No.: 19/469,812

(22) PCT Filed: Mar. 28, 2024
(86) PCT No.: PCT/EP2024/058726

§ 371 Date: Sep. 26, 2025

(30) Foreign Application Priority Data
Mar. 29, 2023 (EP) 23315068.9

(51) Int. Cl. B41J 31/12; B41J 2/325; B41J 33/10; B41J 33/26

(52) U.S. Cl. CPC B41J 31/12; B41J 2/325; B41J 33/10; B41J 33/26

(57) ABSTRACT

A multilayer ribbon device intended to be mounted onto a conveyor of a thermal transfer printing apparatus, the multilayer ribbon device including an endless ribbon, the endless ribbon including an inner face and an outer face, an inner cover removably covering the inner face, and an outer cover removably covering the outer face.

### FIELD OF THE INVENTION

The present disclosure relates to ribbons for thermal transfer printing apparatus.

### BACKGROUND

Current solutions involving a thermal transfer printing apparatus use disposable coated ribbon. One limitation of these solutions is that the ribbon needs to be replaced periodically as the end of the ribbon has been reached.

To cope with the disposal of such used ribbon along with the remaining un-transferred ink, in an alternative class of thermal transfer printing apparatus, an endless ribbon is continuously coated and exposed to the thermal transfer printhead. The non-printed ink may then be recovered as to rejuvenate the coated layer for a next print.

Such solutions offer the opportunity of reusing the remaining portion of the ink and generating reduced waste compared to disposable ribbons.

For such thermal transfer printing apparatuses, an endless ribbon is transported relative to a frame of the printing apparatus by a conveyor such that a part of the ribbon is exposed to the thermal transfer printhead. It is an objective to use a ribbon capable of withstanding a large number of cycles, for example multiple million cycles through the system. This imposes, among other steps, coating new ink continuously onto the ribbon to ensure the homogeneity of the layer of ink on the ribbon for printing.

One limitation of the use of endless ribbons is that the ribbon still must be replaced after several cycles when the ribbon reaches the end of its lifetime. However, a manual replacement of a ribbon implies taking precautions not to damage it.

The US patent U.S. Pat. No. 3,460,666 A discloses a patent by Ploeger Walter Jr where the ribbon has a configuration of a Möbius strip. Such ribbon is a multilayer ribbon having a Mobius strip configuration and prone to be used in printers that could release the ink stored inside its porous structure.

An aim of the invention is to reduce at least one of the above-mentioned limitations.

### SUMMARY

The invention relates to a multilayer ribbon device intended to be mounted onto a conveyor of a thermal transfer printing apparatus, the multilayer ribbon device comprising:
an endless ribbon, the endless ribbon comprising an inner face and an outer face,
an inner cover removably covering the inner face,
an outer cover removably covering the outer face.

Advantageously, the inner cover, the outer cover and the endless ribbon are assembled such that the inner cover and the outer cover can be removed, i.e. separated from the ribbon, without damaging the ribbon.

Advantageously, the endless ribbon is temporarily fastened to at least one of the inner cover and of the outer cover or unfastened to the inner cover the outer cover.

Advantageously, the endless ribbon is intended to be used by the thermal transfer printing apparatus to print a substrate.

Advantageously, the multilayer ribbon device is configured such that the outer cover and the inner cover are intended to be removed before using the thermal transfer printing apparatus to print a substrate using the ribbon.

Advantageously, the endless ribbon is substantially a cylinder.

Advantageously, the ribbon is fluid-tight.

Advantageously, the inner cover substantially entirely covers the inner face and the outer cover substantially entirely covers the outer face.

Advantageously, the multilayer ribbon device comprises a set of at least one separation line to allow the delamination of the multilayer ribbon device from the separation line.

Advantageously, the set of at least one separation line comprises a set of at least one line of weakness, at least one cover among the inner cover and the outer cover being weakened along a line of weakness of the set of at least one line of weakness to guide a sever of the cover along the line of weakness.

Advantageously, a mean straight line of at least one separation line of the set of at least one separation line is a tilted straight line.

Advantageously, the multilayer ribbon device comprises a set of at least one tab arranged such that delamination of the multilayer ribbon device from at least one separation line of the set of at least one separation line is intended to be provoked by pulling the tab.

Advantageously, the set of at least one tab comprises a first tab of the outer cover and a first tab of the inner cover facing each other to be intended to be pulled simultaneously.

The invention also relates to a thermal printing apparatus comprising a frame and a conveyor onto which the multilayer ribbon device is intended to be mounted such that the conveyor supports the multilayer ribbon device and is intended to displace the multilayer ribbon device along a predetermined path of the multilayer ribbon device relative to the frame.

Advantageously, the thermal printing apparatus comprises at least one receptacle delimiting a cavity and being mounted onto the frame to be intended to cooperate with at least one cover among the outer cover and the inner cover when the multilayer ribbon device is mounted onto the conveyor such that when the conveyor displaces the multilayer ribbon device relative to the frame along the path in a predetermined direction, the cover is removed and gathered in the cavity.

The thermal printing apparatus comprising at least one receptacle delimiting a cavity and being mounted onto the frame to be intended to cooperate with at least one cover among the outer cover and the inner cover such that when the conveyor displaces the multilayer ribbon device mounted onto the conveyor relative to the frame along the path in a predetermined direction, the cover is removed, removal of the cover starting from a separation line of the set of at least one separation line and gathered in the cavity.

The thermal printing apparatus comprises at least a couple of compression rollers mounted onto the frame to be intended to press the multilayer ribbon device when the multilayer ribbon between the two compression rollers is mounted on the conveyor.

The invention relates to a method for mounting an endless ribbon of a multilayer ribbon device onto the conveyor of the thermal transfer printing apparatus comprises:
mounting the multilayer ribbon device onto the conveyor,
removing the inner cover and the outer cover.

Advantageously, the method comprises removing at least one cover among the inner cover and the outer cover from a separation line of the set of at least one separation line.

Advantageously, the step of removing the inner cover and the outer cover comprises severing at least one cover among the inner cover and the outer cover along a line of weakness.

Advantageously, the method comprises using the conveyor to displace the multilayer ribbon device relative to the frame to provoke at least one of making at least one cover among the inner cover and the outer cover cooperate with the receptacle, removing the cover and gathering the cover in the cavity.

The invention also relates to a method of manufacturing a multilayer ribbon device comprising:
providing the endless ribbon, the endless ribbon comprising an inner face and an outer face;
removably covering the inner face with the inner cover;
removably covering the outer face with the outer cover.

The invention also relates to a method of printing a substrate comprising mounting the endless ribbon of the multilayer ribbon device onto the conveyor of the thermal transfer printing apparatus according to the invention, displacing the endless ribbon after removal of the inner cover and the outer cover along a predetermined path relative to the frame using the conveyor while continuously coating the outer face of the endless ribbon with a coating composition and transferring the coating composition coating the outer face of the ribbon onto the substrate.

The invention relates to an assembly comprising the thermal transfer printing apparatus and the multilayer ribbon device mounted onto the conveyor.

### BRIEF DESCRIPTION OF THE DRAWINGS

FIG. 1 is a schematic representation of a thermal transfer printing apparatus and of a multilayer ribbon device according to a first example of the invention intended to be mounted on a conveyor of the thermal transfer printing apparatus,

FIG. 2 is a schematic representation of a section of the multilayer ribbon device according to the first example,

FIG. 3 is a schematic representation of a perspective view of the multilayer ribbon device according to the first example when the covers are in respective covering state,

FIG. 4 is a schematic representation of detail of a perspective view of the multilayer ribbon device according to the first example illustrating the removal of the tabs, the covers being in respective removal states,

FIG. 5 is a schematic representation of the thermal transfer printing apparatus and of the multilayer ribbon device when an operator is manually pulling the tabs,

FIG. 6 is a schematic representation of a detail in a perspective view of the multilayer ribbon device according to a second example of the invention illustrating the pull of the tabs,

FIG. 7 is a schematic representation of a multilayer ribbon device according to a third example of the invention and receptacles, the covers being in their covering states,

FIG. 8 is a schematic representation of the multilayer ribbon device of FIG. 7 once the covers of the multilayer ribbon device have been removed and are gathered inside the receptacles,

FIG. 9 is a schematic representation of the multilayer ribbon device of FIG. 7 after removal of the covers of the multilayer ribbon device from the receptacles,

FIG. 10 is a schematic representation of elements of the thermal transfer printing apparatus of FIG. 1.

### DETAILED DESCRIPTION

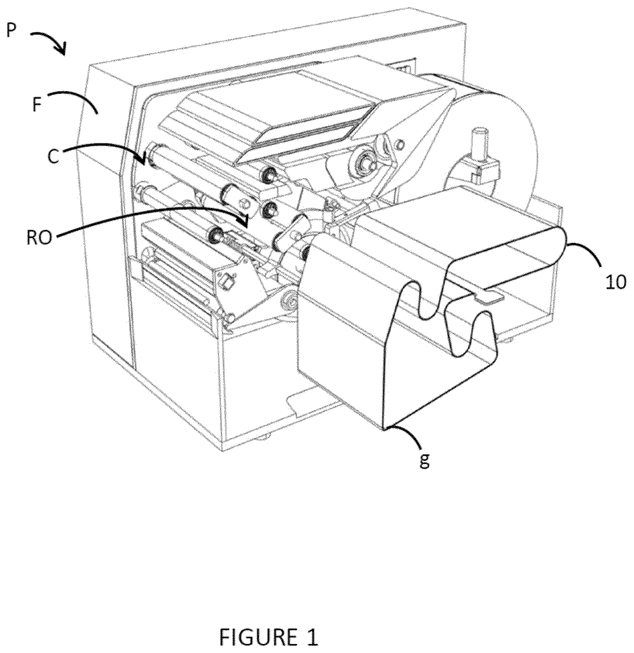

The invention relates to a thermal printing apparatus P comprising a conveyor C as shown on FIG. 1.

More particularly, the invention relates to a thermal transfer printing apparatus P.

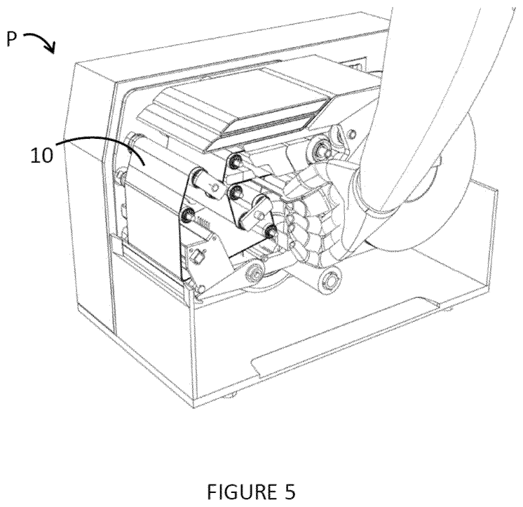

The invention also relates to a multilayer ribbon device 10 comprising an endless ribbon for thermal printing apparatus. The multilayer ribbon device 10 and the endless ribbon being intended to be mounted on the conveyor C as shown on FIG. 5.

The endless ribbon is intended to be used by the thermal transfer printing apparatus P to transfer a part or a selective part of a coating layer on a substrate. By endless ribbon, we mean a ribbon forming a closed loop. The endless ribbon is substantially a cylinder having a generatrix g.

More generally by endless element, we mean an element forming a closed loop.

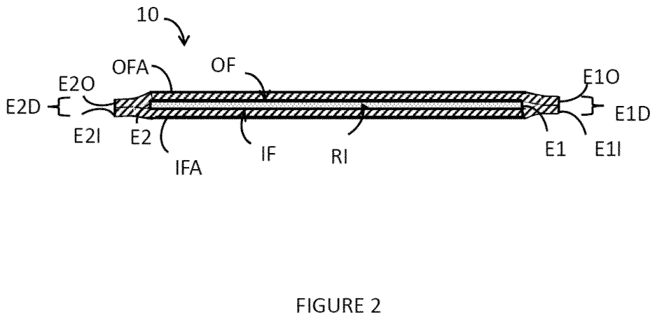

By multilayer ribbon device 10 comprising an endless ribbon, we mean a device comprising a plurality of layers, one of the layers being the endless ribbon RI referenced on FIG. 2.

### Multilayer Ribbon Device

FIG. 2 shows a cross section of a first example of a multilayer ribbon device 10 shown on FIG. 1.

The multilayer ribbon device 10 comprises the endless ribbon RI. The endless ribbon RI comprises and is radially delimited by an inner face IF and an outer face OF.

The inner face IF and the outer face OF are endless surfaces delimiting the endless ribbon RI and facing each other. The outer face OF surrounds the inner face IF.

This configuration allows warranting the cleanliness of the inner face of the ribbon RI which is the only face of the ribbon which is intended to be in contact with the printhead.

The multilayer ribbon device 10 according to the invention further comprises:
a removable inner cover IFA covering the inner face IF;
a removable outer cover OFA covering the outer face OF.

In other terms, these covers are intended to be removed, that is to say separated from the endless ribbon RI. This means that the multilayer ribbon device 10 is intended to be delaminated.

In other terms, each one of the inner cover IFA and the outer cover OFA is a packaging packaging, packaging the endless ribbon.

This configuration allows mounting the multilayer ribbon device 10 onto the conveyor C and to remove the inner cover IFA and the outer cover OFA before printing, i.e. before using the thermal transfer printing apparatus P to print a substrate using the coated or coating layer applied to the ribbon RI.

Therefore, this arrangement limits the risks of damaging the endless ribbon RI during manual installation of the endless ribbon RI onto the conveyor C of the thermal transfer printing apparatus P. It renders this installation easier. For example, it limits the wrinkles and deformations when mounting the endless ribbon RI onto the conveyor C.

In other words, the multilayer ribbon device 10 is a device comprising an endless ribbon RI which is configured to be used by a thermal transfer printing apparatus to print a substrate.

Advantageously, the multilayer ribbon device 10 is configured such that only the ribbon RI among the ribbon RI, the inner cover IFA and the outer cover OFA is intended to be used by the thermal transfer printing apparatus to transfer a part or parts of a coating layer onto a substrate.

That is to say, the multilayer ribbon device 10 is configured such that the endless ribbon RI is configured to be used as an endless ribbon in a thermal transfer printing apparatus only once the removable inner cover IFA and the removable outer cover OFA have been removed.

Therefore, the inner cover IFA and the outer cover OFA are protecting covers configured and arranged to protect the ribbon RI the use of the ribbon for printing.

This arrangement allows positioning the ribbon RI onto a tool, such as a removable positioning device, or into the printer without touching any face of the ribbon RI and to limit contamination of the ribbon RI, for example by dust.

By a removable positioning device, we mean a support onto which the multilayer ribbon device 10 is intended to be mounted. Once the multilayer ribbon device 10 is mounted onto the removable device, the removable device is mounted on the frame F. By moving an element of the removable positioning device relative to the frame, the multilayer ribbon device 10 is transferred from the removable device to the conveyor C such that the removable positioning device can be removed from the frame while the multilayer ribbon device 10 remains mounted onto the conveyor C. Such a removable positioning device allows avoiding manual touching of the multilayer ribbon device 10 when mounting the multilayer ribbon device 10 onto the conveyor C. An example of a removable positioning device is disclosed in the international patent application WO2022/162195 A1 filed by the applicant.

This solution also allows to limit the risks of tearing the endless ribbon RI when separating each of the covers from the ribbon RI. The presence of the two covers allows balancing the force exerted on the ribbon RI during this step.

This solution is easy to manufacture because the endless ribbon RI is not permanently fastened to the covers IFA, OFA and permits to maintain the integrity of the multilayer ribbon device 10, for example during transport.

The inner cover IFA, IFA′, IFB and the outer cover OFA, OFA′, OFB may limit the endless ribbon's RI shrinkage during its storage. It may also limit the endless ribbon's RI corrugation during its installation within the printer.

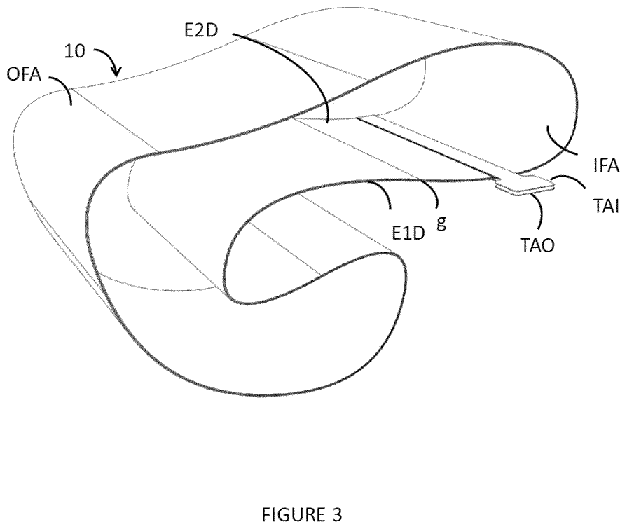

Advantageously, as shown on FIG. 2, the covers IFA, OFA face each other. This allows to limit the risk of tearing the endless ribbon RI when separating the covers from the ribbon RI which is not allowed when covering a single face of the ribbon RI. Advantageously, the inner cover IFA substantially entirely or entirely covers the inner face IF and the outer cover OFA substantially entirely or entirely covers the outer face OF as shown on FIG. 3. This allows to protect the whole endless inner face IF and the whole endless outer face OF.

This allows to protect the whole surface of the endless inner face IF and the whole surface of the endless outer face OF during the installation, which facilitate the installation of the multilayer ribbon device 10 on the conveyor C without touching the ribbon RI. This also limits wrinkles and deformation of the endless ribbon RI when mounting the multilayer ribbon device 10 onto the conveyor C and allows to limit the risk of tearing the endless ribbon RI when separating the covers from the endless ribbon RI.

By substantially entirely covers a face, we mean that the cover entirely covers the surface except at eventual separation lines, for example, line(s) of weakness which will be defined later.

In an embodiment, the inner cover IFA and/or the outer cover OFA are endless covers or as shown on FIG. 3.

The ribbon RI is delimited by a first edge E1 and by a second edge E2 that are endless edges facing each other and distant from each other along the generatrix g direction.

The first edge E1 and the second edge E2 delimit the ribbon RI along the generatrix g direction. In other terms, the first edge E1 and the second edge E2 delimit the width of the ribbon RI. The inner cover IFA and respectively the outer cover OFA are delimited by a first edge E11 of the inner cover IFA, respectively a first edge E10 of the outer cover OFA, and by a second edge E21 of the inner cover OFA, respectively a second edge E20 of the outer cover OFA.

Advantageously, the endless ribbon RI is completely or substantially enclosed in a closed envelope comprising the inner cover IFA and the outer cover OFA. In other terms, the inner cover IFA and the outer cover OFA delimit a substantially closed space receiving the endless ribbon RI.

By substantially closed envelope, we mean a closed envelope except at eventual separation lines or line(s) of weakness which will be defined later.

This allows a complete or substantially complete protection of the ribbon RI. This permits to avoid the need for an adhesive to stick the ribbon RI to each of the covers.

Alternatively, only the outer cover OFA or the inner cover IFA or no one of these covers is an endless cover and/or only the outer cover OFA or the inner cover IFA or no one of these covers substantially covers the inner face IF or the outer face OF of the ribbon RI.

Advantageously, the inner cover IFA is removably attached to the outer cover OFA to form closed edges E1D, E2D of the multilayer ribbon device 10 positioned such that the two edges E1, E2 of the endless ribbon RI are situated between the closed edges E1D, E2D delimiting the multilayer ribbon device 10 along the generatrix direction.

Alternatively, the edges E1D, E2D of the multilayer ribbon device 10 comprise the edges E1, E2 of the endless ribbon RI.

In an embodiment, the inner cover IFA is temporarily fastened to the outer cover OFA.

That is to say, the inner cover IFA is fastened to the outer cover OFA such that the inner cover IFA and the outer cover OFA can be separated from each other without damaging any of the inner cover IFA and of the outer cover OFA.

This configuration is also applicable to an opened envelope.

The inner cover IFA and the outer cover OFA are for example fixed to each other by electrostatic forces.

Alternatively, or in addition, the inner cover IFA and the outer cover OFA are for example attached to each other by folding at least one of the covers, and/or by a repositionable adhesive.

In an example, the multilayer ribbon device comprises at least one attach which temporarily fastens the inner cover IFA to the outer cover OFA.

In another embodiment, the inner cover IFA is permanently fastened to the outer cover OFA.

By the inner cover being permanently attached to the outer cover, we mean that they are attach to each other such that the separation of the inner cover from the outer cover damages at least one of the inner cover and the outer cover.

When removed, the inner and/or outer cover may be damaged since they do not participate to the printing operation by thermal transfer.

The inner cover IFA and the outer cover OFA are for example attached to each other by an adhesive or by welding.

As previously specified, the inner cover, the outer cover and the ribbon are advantageously assembled such that the inner cover and the outer cover can be removed, i.e. separated from the ribbon RI, without damaging the ribbon RI.

An advantage is to ensure a good protection of the ribbon even when removing the covers. Protection of the ribbon further ensures a good and controlled printing quality.

Advantageously, the endless ribbon RI is unfastened to the inner cover IFA and to the outer cover OFA.

Therefore, the endless ribbon RI is free to move relative to the inner cover IFA and to the outer cover OFA in the closed space delimited by the closed envelope.

An advantage is to avoid the use of any additional element to fasten the ribbon to each of the covers, for example for an adhesive to stick the ribbon to each of the covers IFA, OFA. Another advantage is to limit the forces exerted on the ribbon RI when removing the covers as explained later.

Another advantage is to ensure an easy separation of the inner cover IFA and of the outer cover OFA from the ribbon RI.

This configuration is also applicable to an opened envelope.

The inner cover IFA and the outer cover OFA are for example fixed to each other by electrostatic forces.

Alternatively, or in addition, the inner cover IFA and the outer cover OFA are for example attached to each other by folding at least one of the covers, and/or by an adhesive and/or by welding.

Alternatively, at least one of the covers is fastened to the ribbon RI.

Advantageously, at least one of the covers among the inner cover IFA and the outer cover OFA is temporarily fastened to the ribbon RI.

By a cover temporarily fastened to the ribbon, we mean that the cover is fastened to the ribbon RI such that the ribbon and the cover can be separated from each other without damaging the ribbon RI.

In an example, the multilayer ribbon device comprises at least one attach temporarily fastening the cover to the ribbon RI.

For example, the multilayer ribbon device comprises a release agent temporarily fastening the ribbon RI to the cover such that the ribbon RI is not damaged when removing the cover.

In other words, the multilayer ribbon device may comprise a repositionable adhesive temporarily fastening the cover to the ribbon RI.

In another example, the multilayer ribbon device further comprises at least one attach temporarily fastening the cover to the ribbon RI.

An attach may be, but not limited to, a paper clip, a clamp, for example a clamp with flat jaws.

In an example, the multilayer ribbon device comprises a plurality of attaches temporarily fastening the cover to the ribbon RI.

In another example, the ribbon RI is temporarily fastened to at least one of the covers by electrostatic forces.

In an example, each cover among the inner cover IFA and the outer cover OFA is temporarily fastened to the ribbon RI.

In another example, a first cover among the inner cover IFA and the outer cover OFA is temporarily fastened to the ribbon RI and a second cover among the inner cover IFA and the outer cover OFA is unfastened to the ribbon RI.

In another embodiment, the ribbon RI is permanently fastened, for example by welding and/or by an adhesive.

### Materials

At least one of the covers, for example each cover, comprises a plastic sheet, a polyester sheet or a sheet of paper. Each cover can be a multilayer cover or a monolayer cover.

For example, at least one cover may comprise a printed layer separated from the ribbon by another layer of the cover. Therefore, the cover can bear data when the printed layer comprises readable data. This doesn't damage the ribbon.

Each cover may comprise a single individual cover a plurality of individual covers.

In an embodiment, at least one cover is one-piece.

For example, in the examples of the figures, each of the two covers OFA, IFA is one-piece.

The inner cover IFA, IFA′, IFB and the outer cover OFA, OFA′, OFB may contain a moisturizing or preservation compound, such as but not limited to UV absorber, gas resistance, light fastness, resistance to chemical migration, abrasion and scratch resistance. It advantageously extends the durability of the ribbon RI. It may comprise an anti-fake feature or printed image for authenticity recognition.

The inner cover IFA, IFA′, IFB and/or the outer cover OFA, OFA′, OFB may not comprise ink or pigment.

The inner cover IFA, IFA′, IFB and/or the outer cover OFA, OFA′, OFB may comprise a water-soluble material (like polyvinyl alcohol PVA) or a recyclable material. This allows to manage the disposal of the cover after it is removed.

The inner cover IFA, IFA′, IFB and the outer cover OFA, OFA′, OFB may advantageously allow the ribbon to be curled and stored, with the tab sticking out.

The ribbon RI may be made of various materials. The ribbon RI may be made in or may comprise any flexible material such as an elastomer, a thermosetting resin or a thermosetting plastic such as polyimide, a cork band or a sheet of metal, such as stainless steel or titanium.

The ribbon RI may also be a multilayer ribbon. It can comprise two external layers separated by at least one additional layer.

The two external layer may be made of any flexible material such as an elastomer, a thermosetting resin or a thermosetting plastic such as polyimide, a cork band or a sheet of metal, such as stainless steel or titanium.

The additional layer may be configured to improve thermo-mechanical properties, anti-fouling or slippage to the printhead. Said additional layer may comprise a plastic material, for example silicone or a fluoropolymer.

The ribbon RI is preferably made of one or a plurality of materials having high temperature resistance properties, such as temperature resistance equal or higher than 300° C., and high chemical resistance properties, for example a chemical resistant to alcohol, ink or solvents, etc.

Preferably, the ribbon RI is made of polyimide. The polyimide allows the ribbon to be used at high temperatures up to the range [340°-380°] without undergoing deformation.

Alternatively, the ribbon RI may be made of metal or metal alloy such as titanium alloy.

The ribbon RI is preferably made of one or a plurality of materials that has a heat transfer rate greater than 0.120 Watts/meter-Kelvin.

The thickness and the composition of the ribbon material are advantageously designed to create heat transfer through the ribbon RI allowing the thermal printing.

Preferably, the thickness of the ribbon RI is inferior to a thickness threshold. The threshold is inferior or equal to 50 μm. The threshold is for example 20 μm. Said thickness advantageously allows a good thermal conduction through the ribbon.

The thickness of the ribbon RI may be comprised between substantially 0.5 μm and 50 μm, most preferably between 0.5 μm and 20 μm. In one example, the thickness of the ribbon RI is chosen in the range [3-25 μm] or [5-10 μm].

The ribbon RI is advantageously designed to retain the coating composition on its outer face OF.

The ribbon RI or its outer face OF is preferably fluid-tight.

For example, the ribbon IR is non-porous.

Therefore, when coating the ribbon RI with a coating layer, the coating layer doesn't penetrate in the volume delimited by the outer face OF and the inner face IF. Then, when coating the ribbon RI with a coating layer, the inner face of the ribbon always stays exempt of coating composition.

Another advantage is to avoid fouling the inner face of the endless ribbon RI intended to be in contact with the printhead. Conversely, the transfer of the coating composition from the outer surface to the inner surface would result in fouling the printhead and prematurely damage its surface resulting in poor and uncontrolled printing quality.

Moreover, it permits to avoid overflow or spills of coating composition which could be accumulated in the volume delimited by the inner face and the outer face. Such an overflow or spills would impact printing quality or damage the print head.

In one embodiment, the ribbon RI is textile-free or fabric r-free.

### Separation Lines

Advantageously, as shown FIGS. 3 to 7, the multilayer ribbon device 10 comprises a set of at least one separation line CAI1, CAI2, CAI′, CBI, CBO to allow to delaminate the multilayer ribbon device 10, 20, 100 from the separation line, i.e., to remove at least one cover among the inner cover and of the outer cover from the separation line.

Advantageously, each one of the covers is able to be in a covering state in which the covers entirely or substantially entirely cover the ribbon RI and in a removal state in which the removal of the cover has begun.

Advantageously, each separation line extends from a second edge E21, E20 toward a first edge E11, E10 of the one of the covers IFA, IFA′, IFB, OFA, OFA′, OFB.

In the non-restrictive example of FIG. 2, the edge E1D, respectively E2D, of the multilayer ribbon device 10 comprises the edges E11, E10, respectively E21, E20, of the covers.

Advantageously, at least one separation line CAI1, CAI2, CAI′, CBI, CBO extends from the first edge E1D of the multilayer device to the second edge E2D of the multilayer device along the generatrix.

In the non-limiting examples of the figures, each separation line is a line of weakness which will be described below.

Alternatively, at least one of the separation lines is a gap, or slit or blank line, continuously separating two edges of a cover from the first edge of the cover to the second edge of the cover. Edges of the two covers can be separated by respective separation lines.

When the multilayer ribbon device comprises at least two slits, each slit continuously separating two edges of the corresponding cover from the first edge of the cover to the second edge of the cover, the cover comprises at least two individual covers separated by the slit.

When the multilayer ribbon device comprises a single gap continuously separating two edges a cover from the first edge of the cover to the second edge of the cover, the corresponding cover forms an open loop.

We describe below non-limiting examples in which the separation lines CAI1, CAI2; CAI′, CBI, CBO are lines of weakness. It is to be noted that alternatively, at least one of these lines of weakness, for example each of these lines of weakness could be a slit or gap as described above.

In the examples of the figures, each cover IFA, OFA, IFA′, OFA′, IFB, OFB comprises at least one line of weakness CAI1, CAI2; CAI′, CBI, CBO.

Therefore, each cover is weakened along at least one line of weakness.

Each line of weakness CAI1, CAI2; CAI′, CBI, CBO allows to delaminate the multilayer ribbon device from the line of weakness.

More precisely, each line of weakness CAI1, CAI2; CAI′, CBI, CBO guides the tear, or sever or cut of the inner or outer cover along the whole length of the line of weakness.

It allows to facilitate the removal of the covers, in particular when the covers are endless covers. Indeed, each cover may be severed along at least one line of weakness to begin to separate the cover from the ribbon RI.

Advantageously, at least one line of weakness is arranged to permit to open a loop formed by the cover by severing the cover along the line of weakness.

This facilitates the removal of the cover. After having severed the cover along the whole width of the cover, an operator only has to pull the cover along the length of the cover to totally separate the film from the ribbon RI. It allows limiting the forces exerted on the ribbon RI when separating the cover from the ribbon RI.

For example, at least one cover comprises a plurality of perforations or notches or slits or openings distributed along a line such that the cover is weakened along this line forming a line of weakness.

In another example, at least one cover has a predetermined thickness and is thinner along a line of weakness such that the cover is weakened along this line of weakness. In other terms, at least one cover comprises at least a groove along the line of thickness, for example a single groove extending along the whole length of the line of weakness.

These examples are not restrictive.

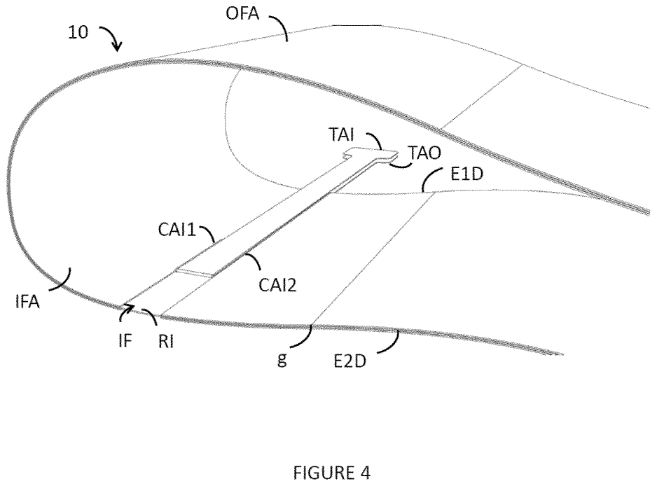

In the first example shown on FIGS. 3 to 4, each one of the inner cover IFA and of the outer cover OFA is weakened along two lines of weakness CAI1, CAI2.

Alternatively, at least a cover can be weakened along more than two lines of weakness or along a single line of weakness.

The following features are applicable to lines of weakness and to slits. Each separation line CAI1, CAI2 may be a straight line parallel to the generatrix g direction, as shown on FIGS. 3 and 4.

Other shapes and orientations are possible.

For example, the straight line may be inclined with respect to the generatrix direction. In other terms, the straight line is a tilted straight line.

Alternatively, at least one separation line is a curved line.

The form of the curved line is a sinusoidal wave or a sawtooth wave.

The curved line may extend along a mean straight line.

The mean straight line may be parallel to the generatrix g direction or inclined with respect to the generatrix g direction. In other terms, the mean straight line is a tilted straight line.

In an embodiment, at least two separation lines are superimposed. In other terms, these separation lines are facing each other along the whole length of these separation lines. An advantage is to balance the forces applied to the endless ribbon RI on both sides of the endless ribbon RI when simultaneously delaminating the two covers from the two superimposed separation lines, for example when simultaneously severing the inner cover IFA and the outer cover OFA along these lines of weakness (when the superimposed separation line are lines of weakness), and hence limiting the risks of tearing and of deforming the endless ribbon RI.

### Tabs

Advantageously, at least one of the inner cover IFA and the outer cover OFA comprises at least one tab TAI, TAO.

The tab TAI, TAO is intended to be pulled, for example manually by an operator, and is arranged such that delamination of the multilayer ribbon device from at least one separation line of the set of at least one separation line CAI1, CA12 is intended to be provoked by pulling the tab TAI, TAO relative to the endless ribbon RI.

An advantage is to facilitate the removal of the covers without touching the endless ribbon RI. For example, the tab is arranged such that severing of the corresponding cover IFA, OFA along at least one line of weakness, for example along two lines of weakness CAI1, CAI2 of the corresponding cover IFA, OFA as shown on FIGS. 3 and 4, is provoked by pulling the tab TAI, TAO relative to the ribbon RI.

Advantageously, at least two tabs TAI and TAO face each other to be intended to be pulled simultaneously relative to the ribbon RI.

In the particular example of FIG. 5, the tabs TAI and TAO are pulled manually by an operator.

An advantage is to facilitate the delamination. Another advantage is to limit the risks of tearing and of deforming the endless ribbon RI when pulling the tabs.

Advantageously, at least two tabs TAI and TAO are superimposed. In other terms, the tabs have the same shape and dimensions and face each other over the entire faces of the tabs facing each other.

The tabs TAI and TAO may be unfastened to each other.

Alternatively, the tabs are affixed to each other.

In the embodiment of FIGS. 3 and 4, each of the two tabs TAO, TAI extends between two lines of weakness CAI1, CAI2 of the corresponding cover and is delimited by the two lines of weakness CAI1 and CAI2.

Advantageously, at least one tab, for example each tab, is intended to transversally protrude from a part of one of the two edges of the multilayer ribbon device 10 which is perpendicular to the generatrix g direction axis x, in the covering state, i.e., to protrude from this part of the first edge ED1 along the generatrix g direction.

In the examples of FIGS. 3 to 6, each one of the inner cover IFA, IFA′ and the outer cover OFA, OFA′ comprises a tab TAI, TAO, TAI′, TAO′ intended to transversally protrude, or transversally protruding, from a part of the first edge E1D of the multilayer ribbon device 10, the part of the first edge E1D extending perpendicular to the generatrix g direction, when the corresponding cover is in the covering state.

### Second Example

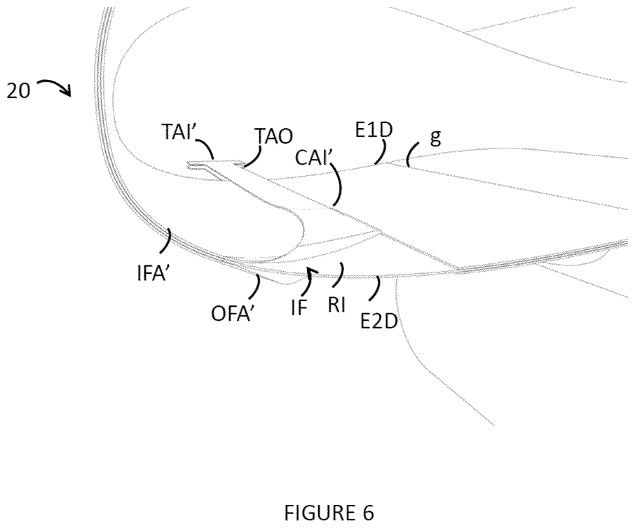

FIG. 6 shows a second example of a multilayer ribbon device 20 according to the invention. This example differs from the first example of FIGS. 3 to 5 in that each one of the inner cover IFA′ and of the outer cover OFA′ is weakened along only one line of weakness CAI1′. Only the line of weakness CAI1′ of the inner cover IFA′ is visible on FIG. 6.

Therefore, the tab TAI′ of the inner cover IFA′ and of the tab TAO′ of the outer cover IFO′ differ from those of FIGS. 3 to 5 in that each of them is intended to be pulled, for example manually by an operator, to sever the corresponding cover IFA′, OFA′ along a single line of weakness CAI1′ of the corresponding cover IFA′, OFA′. Therefore, while pulling the tab, the delamination may start. Moreover, this configuration allows peeling off both faces of the ribbon RI at the same time. The onset of the delamination is smoothened (the tabs bring the cover along). The cover's removal is assisted and may be carried out by an unexperienced operator (no need for long training or dexterity).

The example of FIG. 6 also differs from the first example shown on FIGS. 3 to 5 in that each tab TAI′, TAO′ is designed to be able, when the films are in their respective covering states, to be in a first position, represented on FIG. 6, in which it transversally protrudes from the part first edge E1D of the multilayer ribbon device 20 extending perpendicular to the generatrix g direction, and in a second position in which it transversally protrudes from the second edge E2D of the multilayer ribbon device 20 perpendicular to the generatrix g direction. Each tab is intended to be displaced from the first position to the second position by unfolding the corresponding cover, for example along the second edge E2D of the multilayer ribbon device 20. This configuration is also applicable to the first and third examples.

Alternatively, as in the first and third examples, at least one tab is only able to protrude from the first edge E1D of the multilayer ribbon device 20 in the covering state when the cover is in the covering state.

### Third Example

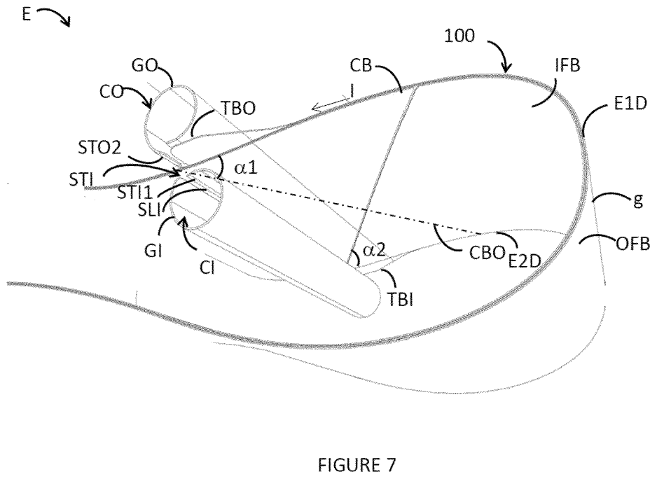

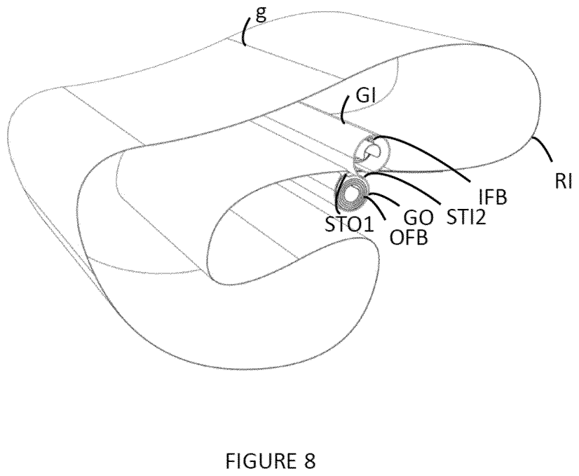

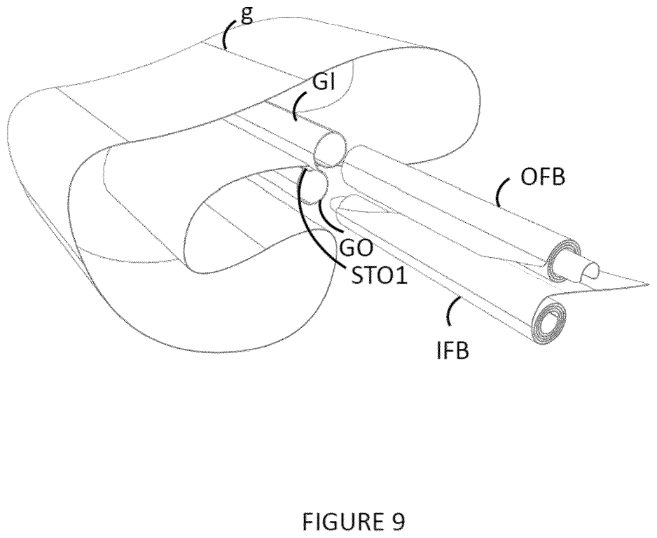

FIGS. 7 to 9 show a multilayer ribbon device 100 according to a third example of the invention.

The multilayer ribbon device 100 according the third example differs from the multilayer ribbon device 10 according to the first example shown on FIGS. 3 and 4 in that each one of the inner cover IFB and of the outer cover OFB of the multilayer ribbon device 100 is weakened along only one line of weakness CBI. The line of weakness CBI of the inner cover IFB is visible on FIG. 7 (plain line) and the line of weakness CBO of the outer cover is represented in a dotted line on FIG. 7.

The multilayer ribbon device 100 further differs from the multilayer ribbon device 10 according to the first example in that each line of weakness CBI, CBO is a tilted straight line. Alternatively, as explained above, the line of weakness is a curved line extending along the mean tilted straight line.

By a tilted straight line, we mean a straight line forming an angle different from 90° with the parts of the first edge E1D and of the second edge E2D of the multilayer ribbon device 100 which extend perpendicular to generatrix g direction. This allows limiting the resultant of the forces exerted on the ribbon RI when severing or cutting each cover along the line of weakness from a respective edge of the multilayer ribbon device 100 which forms an angle different inferior to 90° with the cover and simultaneously recovering the cover in a receptacle as explained later in the text.

Advantageously, the line of weakness CBI or the mean tilted straight line of the inner cover IFB forms a first angle α1, less than 90°, with the part of the first edge E1D of the multilayer ribbon device 100 which extends perpendicular to the generatrix g direction. This allows to limit the force exerted on the endless ribbon RI when severing the cover along the line of weakness from the corner of the first angle α1 toward the first angle α1 pulling the cover from the corner of the first angle toward the angle α1 to fold the cover. This is also applicable when the separation line is a gap instead of a line of weakness.

The first angle α1 is advantageously comprised between 30° and 70°. Advantageously, the first angle α1 is comprised between 45° and 70°. The angle is advantageously comprised between 55° and 65°. It is for example equal to 60°.

Advantageously, the line of weakness CBO of the outer cover OFB forms a second angle α2, less than 90°, with the part of the second edge E2D of the multilayer ribbon device 100 which extends perpendicular to the generatrix direction.

This allows balancing the forces exerted on the ribbon RI when simultaneously severing the outer cover OFB and the inner cover IFB along their respective lines of weakness CBO, CBI from the corners and the first angle α1 and second angle α2 by pulling the respective covers toward their respective angles α1, α2 to fold the covers.

Advantageously, the line of weakness CBI of the inner cover IFB crosses the first edge E1D of the multilayer ribbon device 100 and the line of weakness CBO of the outer cover OFB crosses the second edge E2D of the multilayer ribbon device 100 in same plane perpendicular to the inner face IF and outer face OF of the ribbon RI. This balances the forces exerted on the ribbon RI when simultaneously severing the outer cover OFB and the inner cover IFB along their respective lines of weakness CBO, CBI as explained above and limit the risks of deformation or displacement of the ribbon RI during this operation.

Advantageously, α2=α1. This allows an amelioration of the balance of the forces exerted on the ribbon RI when simultaneously severing the outer cover OFB and the inner cover IFB along their respective lines of weakness CBO, CBI as explained above.

The same advantages are obtained when the separation lines are slits instead of lines of weakness.

Alternatively, these two angles are different.

The multilayer ribbon device 100 further differs from the multilayer ribbon device 10 according to the first example in that the tab TBI of the inner cover IFB transversally protrudes from the first edge E1D of the multilayer ribbon device 100 and in that the tab TBO of the inner cover OFB transversally protrudes from the second edge E2D of the multilayer ribbon device 100.

### Receptacles

The ribbon printing apparatus P may comprise two receptacles GI, GO.

Each receptacle GI, GO delimits a cavity CI, CO and is intended to be mounted on the frame F of the thermal transfer printing apparatus P in a collecting position defined such that a stopper STI, STO of the receptacle GI, GO cooperates with one of the covers IFB, OFB, advantageously with a tab TBI, TBO, such that when the conveyor C displaces the multilayer ribbon device 100 relative to the frame in a predetermined direction represented by an arrow on FIG. 7, the cover OFB, IFB peels itself from the line of weakness, or more generally the separation line, and is gathered in the cavity CI, CO.

In other terms, removal of the cover starts from a separation line.

This allows an automatic delamination of the multilayer ribbon device from their respective lines of weakness or more generally from their separation lines. This allows avoiding manual intervention of an operator. This solution is robust and repeatable and allows avoiding deformation, movement and contamination of the ribbon RI during these operations. This solution is also simple, compact and rapid.

Alternatively, the printing apparatus P comprises only one receptacle.

The faces of the receptacles delimiting the cavity CI, CO intended to receive the covers IFB, OFB are advantageously smooth to avoid friction when collecting the covers IFB, OFB.

Advantageously, the cavity CI, CO is substantially circular cylindrical or essentially cylindrical extending longitudinally along a longitudinal axis of the cavity.

In the example of FIGS. 7 to 9, the cavity CI, CO is substantially circular cylindrical. The section of the cavity, in each plane perpendicular to the longitudinal axis of the cavity, is sensibly a spiral. The spiral forms sensibly one turn (less or more) around the longitudinal axis of the cavity.

Alternatively, the cavity CI, CO is cylindrical having a cross section having a non-circular shape, for example, elliptical, or hexagonal.

Advantageously, each receptacle GI, GO has a stopper STI, STO, intended to cooperate with one of the covers IFB, OFB, and advantageously with one of the tabs TBI, TBO; in the covering state such that when the conveyor C displaces the multilayer ribbon device 100 relative to the frame in a predetermined direction, i.e. rotates the multilayer ribbon device 100 relative to the frame in the predetermined direction, the cover OFB, IFB peels itself off and is gathered in the cavity CI, CO.

Advantageously, each stopper STI, STO, extends continuously along the whole width of the corresponding cover IFB, OFB along the longitudinal axis in the receiving position.

For example, the stopper STI, STO has a straight part STI1, STO1 extending along the longitudinal axis of the cavity and a protrusion STI2, STO2, protruding from the straight part STI1, STO1. This renders easy the beginning of the delamination.

Advantageously, the STI2, STO2 is intended to cooperate with one of the covers IFB, OFB, and advantageously with one of the tabs TBI, TBO; in the covering state such that when the conveyor C displaces the multilayer ribbon device 100 relative to the frame in a predetermined direction, i.e. rotates the multilayer ribbon device 100 relative to the frame in the predetermined direction, the cover OFB, IFB peels itself off and is gathered in the cavity CI, CO.

Alternatively, the stopper STI, STO is straight and extends along the longitudinal axis along the whole length of the cavity CI, CO.

The receptacle is advantageously substantially cylindrical and may comprise a slot SLI extending along the whole length of the cavity of the receptacle. The stopper STI, STO may delimit the slot as shown on FIGS. 7 to 9.

Advantageously, each receptacle GI, GO is dimensioned to be intended to receive the whole corresponding cover in its cavity.

Advantageously as shown on FIG. 7, in the collecting position, each receptacle GI, GO is positioned and oriented relative to frame F such that when the multilayer ribbon device 100 is mounted onto the conveyor C, the longitudinal axis of the cavity is substantially parallel to the generatrix g direction.

Advantageously, in the collecting position, the receptacle GI, GO is positioned such that the stopper STO, STI is in tangential abutment against the tab TBI, TBO when the cover is in the covering state. In other terms the stopper STO, STI is in abutment against the tab TBI, TBO along the path of the tab TBI, TBO when being displaced by the conveyor C in the predetermined direction. This permits to guide the tab toward the cavity when the conveyor C begins to displace the cover.

It is to be noted that alternatively, the printing apparatus may comprise at least one receptacle to gather the covers, for example one or two receptacles, and the multilayer ribbon device according to the first or the second example or to one of their alternatives.

### Method

The invention also relates to a method for mounting a ribbon RI onto a conveyor C of a thermal transfer printing apparatus.

The method comprises:
mounting a multilayer ribbon device 10, 20, 100 onto the conveyor C,
removing the removable inner cover IFA, IFA′, IFB and the removable outer cover OFA, OFA′, OFB.

The step of removing the removable covers is a step of completely removing said covers from the surfaces of the ribbon RI covered by these covers.

Theses covers allow protecting the ribbon during transportation, storage and when mounting the ribbon onto the conveyor of the thermal transfer printing apparatus.

Advantageously, the step of removing the inner cover IFA, IFA′, IFB and the outer cover OFA, OFA′, OFB comprises delaminating the multilayer ribbon device from at least one separation line. In other terms at least one of the inner cover and the outer cover is removed from a separation line.

When the separation line is a line of weakness, this step comprises severing the cover along the line of weakness.

Advantageously, the step of removing the inner cover and the outer cover comprises pulling at least one tab to the multilayer ribbon device from a separation line. This step allows facilitating the separation of the cover from the ribbon RI. In other terms, it allows to facilitate the removal of the cover.

Advantageously, the tabs are pulled simultaneously, as explained in relation to FIGS. 3 to 6.

Each one of these steps may be implemented manually or automatically.

Both manual and automatic removal may be carried out to peel off one cover or both covers simultaneously.

As explained in relation to FIGS. 7 to 9, these steps can be implemented automatically when the receptacles GI, GO are mounted on the frame F of the thermal transfer printing apparatus P to be intended to cooperate with one of the covers IFB, OFB, advantageously with one of the tabs TBI, TBO; such that when the conveyor C displaces the multilayer ribbon device 100 relative to the frame in a predetermined direction, the cover OFB, IFB is gathered in the cavity CI, CO.

For example, the cover is rolled-up in the cavity. Therefore, these steps are implemented by using the conveyor C to displace the multilayer ribbon device 100 relative to the frame such that the multilayer ribbon device 100 follows a closed-loop path in a predetermined direction until the covers IFB, OFB are fully stored inside the respective receptacles GI, GO.

For example, the respective tabs TBO, TBI come in abutment against the respective stoppers STO, STI along the path of the multilayer ribbon device 100 in the direction.

The conveyor C is further used to continue to displace the multilayer ribbon device 100 such that the multilayer ribbon device 100 runs according to the predetermined direction. Therefore, the respective covers OFB, IFB are delaminated along their respective lines of weakness, or more generally from their respective separation line, by the stopper and rolled up in the respective cavities CI, CO of the receptacles GO, GI. Therefore, the removing step comprises the step of tearing the covers.

At the end of this step, the covers OFB, IFB are completely housed in their respective cavity CO, CI.

During these steps, the conveyor C advantageously displaces the multilayer ribbon device 100 at a speed slower than an operating speed, the operating speed being the speed of displacement of the ribbon RI when the printing apparatus P is in a printing mode i.e. when the ribbon RI is used to print a substrate.

Alternatively, the step of removing the covers of FIGS. 3 to 6 can be implemented automatically. The method may comprise severing the inner cover and the outer cover along their lines of weakness or, more generally delaminating these covers from their separation lines, introducing each cover in one of said cavities CI, CO and a step of using the conveyor C to displace the multilayer ribbon device along its path in the direction to roll the respective covers in the cavities.

Advantageously, the ribbon RI is maintained under tension during the step of removing the covers. It permits to limit the risks of deformation and of undesirable movements of the ribbon RI.

### Printing Apparatus

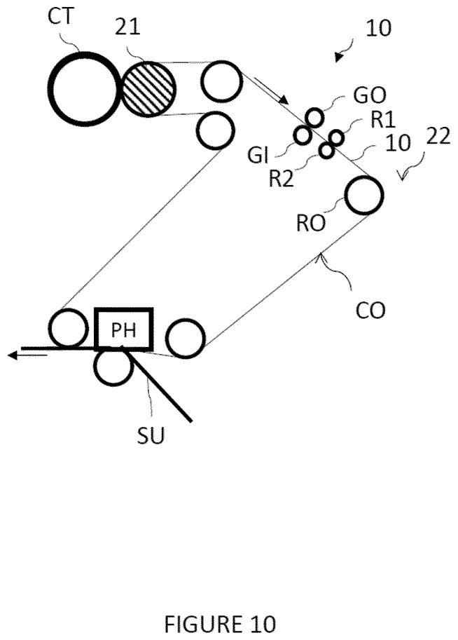

The thermal transfer printing apparatus comprises a conveyor C intended to support and displace the multilayer ribbon device relative to a frame F of the thermal transfer printing apparatus P as shown on FIG. 10.

This allows easy manual delamination of the multilayer ribbon device or this simply allows automatic delamination of the multilayer ribbon device.

The ribbon RI is intended to be used in the thermal transfer printing apparatus to transfer part of a coating layer covering the inner ribbon RI onto a substrate SU.

As previously specified, the multilayer ribbon device is advantageously configured such that the multilayer ribbon device is intended to be used by a thermal transfer printing apparatus to print a substrate only once the inner cover and the outer cover are removed.

In other words, the multilayer ribbon device is advantageously configured such that only the inner ribbon RI of the multilayer ribbon device is intended to be used by a thermal transfer printing apparatus to print a substrate only once the inner cover and the outer cover are removed.

The thermal transfer printing apparatus P further comprises a coater CT to continuously coat the outer face OF of the ribbon RI with a coating composition, for example ink.

The conveyor C is primarily intended to support and displace the endless ribbon RI relative to a frame F of the thermal transfer printing apparatus P to permit to continuously coat the endless ribbon RI with a coating layer, for example a layer of ink, intended to be transferred on a substrate SU via a printhead PH of the thermal printing apparatus P by thermal transfer.

Only the ribbon RI of the multilayer ribbon device 10 is mounted onto the conveyor C when printing, i.e. when coating the outer face OF of the ribbon RI with the coating layer and when using the ribbon RI to transfer part of the coating layer onto the substrate SU.

When the coating composition, for example ink, is coated by the coater onto the outer face OF of the ribbon RI, a coating layer of the coating composition is formed onto the outer face OF of the ribbon RI.

The ribbon RI is intended to be sandwiched between the printhead PH and the substrate RI to transfer the coating layer onto the substrate SU.

More precisely, the ribbon RI is intended to be sandwiched between the printhead PH and the substrate SU such that the coating layer coated onto the outer face OF of the ribbon RI is sandwiched between the substrate SU and the ribbon RI to transfer a selective part or selective parts of the coating layer onto the substrate SU.

The thermal printing apparatus is arranged such that, when transferring a part or parts of the coating layer onto the substrate using the cylindrical endless ribbon RI, the inner face IF of the ribbon RI is in direct physical contact with the printhead PI.

Therefore, the outer face OF of the ribbon RI is never in direct physical contact with the printhead PI.

This configuration ensures cleanliness of the inner face IF of the ribbon RI and absence of coating composition residue on the inner face IS. It permits to avoid printhead fouling which could negatively impact printing quality. This spotlessness ensures a good printing quality and a long duration of the endless multilayer ribbon.

The coater CT may comprise slot-die coating device, an ink roller or any coating device known by the skilled person to coat a ribbon. The conveyor C may comprise a plurality of rollers RO mounted onto a frame F of the thermal printing apparatus P.

The conveyor C is intended to support the endless ribbon RI or the multilayer ribbon device and to move it along a path relative to the frame F of the thermal transfer printing apparatus P. The path of the endless ribbon RI or of the multilayer ribbon device a predefined closed loop being the loop formed by the endless ribbon mounted on the conveyor C, i.e. on the rollers RO. In other terms, when moving along the path the ribbon RI turns around itself.

This is also applicable to the multilayer ribbon device 10, 20, 100.

Advantageously, the printer comprises at least one couple of compression rollers R1, R2 mounted on the frame at the neighborhood of the receptacles GI, GO and arranged to be intended to press the multilayer ribbon device 10 between the two compression rollers R1, R2 when the multilayer ribbon device 10 is mounted onto the conveyor C. This permits to limit the uncontrolled deformations of the ribbon RI during delamination, i.e. during the removing step and it holds the ribbon RI in position during this step.

For example, the compression rollers R1, R2 are mounted onto the frame to be able to be in a first relative position in which they are intended to press the multilayer ribbon device 10 between the two compression rollers R1, R2 when the multilayer ribbon device 10 is mounted onto the conveyor C and in a second relative position in which they are distant from the multilayer ribbon device or from the ribbon RI. This permits to position the compression roller R1, R2 in the first relative position during the removing step and in the second relative position during the use of the printer to print a substrate. This permits to avoid disrupting the print and to damage the ribbon RI.

Advantageously, the two receptacles GI, GO are interposed between too consecutive rollers RO of the C along the path of the multilayer ribbon device 10. The compression rollers R1, R2 are also interposed between these two consecutive rollers.

The shape of the loop depends on the arrangement of the rollers RO relative to the frame.

Each roller RO, R1, R2, is mounted on the frame F to be able to rotate relative to the frame F around itself, i.e. around its respective axes of rotation fixed relative to the frame F.

In an embodiment, each RO, R1, R2 has a circular cylinder shape and is mounted onto the frame F to be intended to rotate around an axis of symmetry of the circular cylinder.

At least one of the rollers RO may be a drive roller having a motor intended to put said drive roller in rotation relative to the frame F, causing the rotation of the other rollers around their respective axes relative to the frame F and the displacement of the ribbon or of the multilayer ribbon device along its path relative to the frame F.

Advantageously, the thermal transfer printing apparatus P may comprise the receptacles GO and GI (or one receptacle) mounted on the frame F.

The receptacles GO and GI may be permanently mounted onto the frame F. In other terms, the receptacles GO and GI and/or the tension rollers R1, R2 may be permanently mounted onto the frame F.

Advantageously, the receptacles GO and GI and the tension rollers R1, R2 can be removably mounted on the frame F.

Advantageously, the receptacles GO and GI and the tension rollers R1, R2 are temporarily fastened to the frame F.

Advantageously, the thermal transfer printing apparatus is able to be alternatively in a delaminating mode and in a printing mode.

In the printing mode, the thermal printing apparatus is configured such that the conveyor displaces the ribbon RI relative to the frame, at an operating speed, such that the ribbon RI follows a closed-loop path, such that the coater continuously coats the outer face OF of the ribbon RI with a coating composition and such that the printhead PI temporarily presses the ribbon RI against a substrate SU to transfer a selective part or selective parts of the coating composition onto the substrate SU.

Advantageously, when the thermal transfer printing apparatus comprises the compression rollers R1, R2, the rollers are in the second relative position in the delaminating mode.

In the delaminating mode, the thermal printing apparatus is advantageously configured to displace the multilayer ribbon device 100 along the closed-loop path, such that the coater doesn't coat the outer face OF of the ribbon with a coating composition and such that the printhead PI is distant from the inner face of the ribbon RI.

Advantageously, the delaminating speed is lower than the operating speed.

Advantageously the multilayer ribbon device 10 is pressed between two compression rollers R1, R2 in the delaminating mode.

Advantageously, the printing apparatus has switching means to switch the printer from the printing mode to the delamination mode or vice versa upon reception of reception of a user's command.

### Printing Method

The invention also relates to a method for printing a substrate using a thermal transfer printing apparatus. The method comprises the step of mounting a ribbon RI onto a conveyor C of a thermal transfer printing apparatus according to the preceding method.

The method also comprises a step of printing a substrate SO, this step comprises using the ribbon RI to transfer a part or selective part of the coating composition coating the outer face of the ribbon RI onto the substrate SU.

During the printing step, the conveyor displaces the ribbon RI relative to the frame, at an operating speed, such that the ribbon RI follows a closed-loop path. During this step, the coater continuously coats the outer face OF of the ribbon RI with a coating composition and such the printhead PI temporarily presses the ribbon RI against a substrate SU to transfer the coating composition coating the outer face of the ribbon RI onto the substrate SU.

### Method of Manufacturing

The invention also relates to a method for manufacturing the multilayer ribbon device.

The method comprises:
providing the endless ribbon RI, the endless ribbon RI comprising an inner face IF and an outer face OF,
removably covering the inner face IF with the inner cover IFA, IFA′, IFB;
   removably covering the outer face OF with the outer cover OFA, OFA′, OFB.

1. A multilayer ribbon device intended to be mounted onto a conveyor of a thermal transfer printing apparatus, the multilayer ribbon device comprising:
an endless ribbon, the endless ribbon comprising an inner face and an outer face,
an inner cover removably covering the inner face,
an outer cover removably covering the outer face.

2. A multilayer ribbon device as claimed in claim 1, wherein the endless ribbon, the inner cover and the outer cover are assembled such that the inner cover and the outer cover can be separated from the endless ribbon without damaging the ribbon.

3. A multilayer ribbon device as claimed in claim 2, wherein the endless ribbon is temporarily fastened to at least one of the inner cover and of the outer cover or unfastened to the inner cover the outer cover.

4. (canceled)

5. A multilayer ribbon device as claimed in claim 1, wherein the multilayer ribbon device is configured such that the outer cover and the inner cover are intended to be removed before using the thermal transfer printing apparatus to print a substrate using the ribbon.

6. A multilayer ribbon device as claimed in claim 1, wherein the endless ribbon is substantially a tight cylinder, wherein the inner cover substantially entirely covers the inner face and the outer cover substantially entirely covers the outer face.

7. (canceled)

8. (canceled)

9. A multilayer ribbon device as claimed in claim 1, comprising a set of at least one separation line to allow the delamination of the multilayer ribbon device from the separation line.

10. A multilayer ribbon device as claimed in claim 9, wherein the set of at least one separation line comprises a set of at least one line of weakness, at least one cover among the inner cover and the outer cover being weakened along a line of weakness of the set of at least one line of weakness to guide a sever of the cover along the line of weakness.

11. A multilayer ribbon device as claimed in claim 9, wherein a mean straight line of at least one separation line of the set of at least one separation line is a tilted straight line.

12. A multilayer ribbon device as claimed in claim 9, comprising a set of at least one tab arranged such that delamination of the multilayer ribbon device from at least one separation line of the set of at least one separation line is intended to be provoked by pulling the tab.

13. A multilayer ribbon device device as claimed in claim 12, wherein the set of at least one tab comprises a first tab of the outer cover and a first tab of the inner cover facing each other to be intended to be pulled simultaneously.

14. A thermal printing apparatus comprising a frame and a conveyor onto which the multilayer ribbon device as claimed in claim 1 is intended to be mounted such that the conveyor supports the multilayer ribbon device and is intended to displace the multilayer ribbon device along a predetermined path of the multilayer ribbon device relative to the frame, the thermal printing apparatus comprising at least one receptacle delimiting a cavity and being mounted onto the frame to be intended to cooperate with at least one cover among the outer cover and the inner cover when the multilayer ribbon device is mounted onto the conveyor such that when the conveyor displaces the multilayer ribbon device relative to the frame along the path in a predetermined direction, the cover is removed and gathered in the cavity.

15. (canceled)

16. The thermal printing apparatus as claimed in claim 14, in which wherein removal of the cover starting from a separation line of the set of at least one separation line

17. The thermal printing apparatus as claimed in claim 14, comprising at least a couple of compression rollers mounted onto the frame to be intended to press the multilayer ribbon device when the multilayer ribbon device between the two compression rollers is mounted on the conveyor.

18. An assembly comprising the thermal printing apparatus as claimed in claim 14 and the multilayer ribbon device mounted onto the conveyor.

19. A method for mounting an endless ribbon of a multilayer ribbon device onto the conveyor of the thermal transfer printing apparatus as claimed in claim 14 comprising:
mounting the multilayer ribbon device onto the conveyor,
removing the inner cover and the outer cover.

20. A method as claimed in claim 19, comprising removing at least one cover among the inner cover and the outer cover from a separation line of the set of at least one separation line.

21. A method as claimed in claim 20, wherein removing the inner cover and the outer cover comprises severing at least one of the inner cover and the outer cover along a line of weakness.

22. A method as claimed in claim 20, wherein the method comprises using the conveyor to displace the multilayer ribbon device relative to the frame to provoke at least one of making one cover among the inner cover and the outer cover cooperate with the receptacle, removing the cover and gathering the cover in the cavity.

23. A method of printing a substrate comprising mounting the endless ribbon of the multilayer ribbon device onto the conveyor of the thermal transfer printing apparatus according to the method as claimed in claim 19, displacing the endless ribbon after removal of the inner cover and the outer cover along a predetermined path relative to the frame using the conveyor while continuously coating the outer face of the endless ribbon with a coating composition and transferring the coating composition coating the outer face of the ribbon onto the substrate.

24. A method of manufacturing a multilayer ribbon device as claimed in claim 1, comprising:
providing the endless ribbon, the endless ribbon comprising an inner face and an outer face;
removably covering the inner face with the inner cover;
removably covering the outer face with the outer cover.
